(19) United States
(12) Patent Application Publication
(10) Pub. No.: US 2020/0298481 A1
(43) Pub. Date: Sep. 24, 2020

(54) ASSISTED FUSED DEPOSITION MODELING

(71) Applicant: Oerlikon AM GmbH, Feldkirchen (DE)

(72) Inventor: Simon Vincent SANKARE, Munchen (DE)

(73) Assignee: Oerlikon AM GmbH, Feldkirchen (DE)

(21) Appl. No.: 16/770,648

(22) PCT Filed: Dec. 10, 2018
(86) PCT No.: PCT/EP2018/084149

§ 371 Date: Jun. 8, 2020

Related U.S. Application Data
(60) Provisional application No. 62/596,204, filed on Dec. 8, 2017.

(51) Int. Cl. B29C 64/209; B29C 64/118; B29C 64/194; B29C 64/295

(52) U.S. Cl. CPC B29C 64/209; B29C 64/118; B33Y 40/20; B29C 64/295; B29C 64/194

(57) ABSTRACT

The present invention relates to a fused deposition nozzle modeling process with a coaxial hot air stream nozzle for process improvement. The coaxial hot stream can help to improve the bonding between layers, increase the deposition rate owing to the controlled excess of energy, and reduce the local stresses due to a better management of the cooling rate. Furthermore if metallic, ceramic powders are added in the hot stream, new properties could be brought to the plastic part, such as for example electrical conductivity, magnetic behavior.

The present invention relates to an extrusion head with a nozzle for fused deposition modeling as well as a method for fused deposition modeling.

Fused deposition modeling is a well-known method for rapid prototyping of solid models. It is the deposition of a heated plastic filament through an extrusion nozzle to create a part. An extrusion head extrudes heated flowable modeling material (such as for example a thermoplastic heated over its glass transition temperature) through a nozzle and deposits it onto a base. During deposition the nozzle moves in an X-Y plane by a numerically controlled layer by layer. By this multiple layer deposition a 3 dimensional object is created. The modeling material thermally solidifies and the finished part is removed from the base.

Very important in this process is the bonding between the layers as this to a high degree determines the stability of the finalized model. It is an objective of the present invention to improve the bonding between layers.

In the part thermal gradients and rapid heating and cooling cycles cause stress. Accordingly, it is an objective in model building systems, which employ thermal solidification to relieve the stresses caused by cooling, in order to minimize the geometric distortion.

The extrusion head arrangement according to the present invention comprises in addition to the nozzle a stream channels arrangement. The stream channel arrangement comprises one or more stream channels for fluids. The nozzle defines an axis of the extrusion head and preferably the stream channel arrangement is arranged coaxial to this axis. The surrounding hot fluid stream heat locally the deposition point and therefore reduce the local thermal gradient in the part.

Fluids in the context of this disclosure could be gases, liquids or powders or mixtures of gases and powders or liquids comprising solid particles.

If for example the fluid is a gas with powder it is possible to embed powder particles in the plastic matrix and especially between the layers. Such powders could be for example metallic powders. With this method it is possible to bring new properties to thermoplastic parts such as for example electrical conductivity and/or magnetic behavior. By controlling the federate of the powder it is possible to insert a unique metallic (magnetic) pattern in models in order to for example make this model traceable.

The method can as well be used to color the model. In order to do so the fluid might comprise coloring particles.

In order to summarize, the present invention particularly relates to a fused deposition nozzle modeling process with a coaxial hot air stream nozzle for process improvement. The coaxial hot stream can help to improve the bonding between layers, increase the deposition rate owing to the controlled excess of energy, and reduce the local stresses due to a better management of the cooling rate. Furthermore, if metallic and/or ceramic powders are added in the hot stream, new properties could be brought to the plastic part, such as for example electrical conductivity and/or magnetic behavior.

The objective of the present invention may be attained by providing an extrusion head arrangement comprising a body with a filament channel with material entrance opening and material exit opening forming a nozzle for the extrusion of flowable material through the exit opening onto a substrate, wherein the extrusion head arrangement in addition comprises a stream channel arrangement with one or more stream channel openings which allows to create a fluid stream close to the exit opening and in direction to the substrate.

In order to use the above described extrusion head arrangement for creating 3-dimensional objects, the extrusion head arrangement preferably should not only be adjustable in the xy-direction, but also in the z-direction. On the other hand, it is also conceivable that, alternatively or cumulatively to the extrusion head arrangement, the substrate can also be adjustable in the x-, y- and z-position.

The present invention further discloses:

An extrusion head arrangement as described above, wherein the stream channel arrangement comprises one or more stream channels as well as one or more stream channel openings, wherein the stream channel openings are arranged coaxially to the nozzle or wherein the one or more stream channels are annular.

An extrusion head arrangement as described in any of the above mentioned embodiments, wherein the exit opening and the one or more stream channel openings are arranged in a plane.

An extrusion head arrangement as described in any of the above mentioned embodiments, wherein the extrusion head arrangement comprises a gas feed system to feed at least one of the one or more stream channels with a gas stream.

An extrusion head arrangement as described above, wherein the gas feed system is designed to enable setting the temperature of the gas.

An extrusion head arrangement as described above, wherein the gas feed system is designed to enable heating the gas at least 20° C. above room temperature. By heating the gas at least 20° C. above room temperature it is possible in particular to improve the bonding between layers, to increase the deposition rate owing to the controlled excess of energy, and to reduce the local stresses due to a better management of the cooling rate.

An extrusion head arrangement as described above, wherein the gas feed system is designed to enable mixing a powder to the gas. By mixing a powder to the gas it is possible in particular to bring up new properties to the plastic part, such as for example electrical conductivity or magnetic behavior.

An extrusion head arrangement as described above, wherein the gas feed system is designed to enable to at least partially ionizing the gas.

An apparatus for fused deposition modeling comprising an extrusion head arrangement as described in any of the above mentioned embodiments.

Furthermore, the objective of the present invention may be attained by providing a method to manufacture a three dimensional object comprising the steps of

a) providing a filament of thermoplastic material,

b) extruding the filament through the nozzle of an extrusion head arrangement as described in any of the above mentioned embodiments and depositing a layer of the thermoplastic material on a surface below the nozzle by moving the nozzle in an X-Y plane,

c) repeating step b) multiple times in order to deposit multiple layers of thermoplastic material

wherein

in a step b1) at least one time after the first layer deposited according to step b) and before the last layer to be deposited according to step c) applying a fluid to at least part of the last already deposited layer, wherein preferably the fluid is applied simultaneously with the deposit of a layer.

Thus, the inventive method has the same advantages as have already been described in detail with regard to the inventive device.

The present invention further discloses:

A method as described above, wherein the extrusion head arrangement is an extrusion head arrangement as described in any of the above mentioned embodiments.

A method as described above, wherein the fluid comprises a gas, preferably air and most preferred hot air.

A method as described above, wherein the fluid is a mixture of the gas and powder particles.

A method as described above, wherein some of the powder particles, preferably all of the powder particles are metallic particles.

A method as described above, wherein step b1 is performed at least half as often as step c).

By the means of the present invention, in particular by using a well positioned hot fluid stream it is possible to improve a fused deposition modeling method. In particular, it is possible to relieve the stresses caused by cooling in a fused deposition modeling method leading to an improved bonding between the deposited layers. Furthermore, with the present invention it is possible to bring new properties to thermoplastic parts such as for example electrical conductivity and/or magnetic behavior.

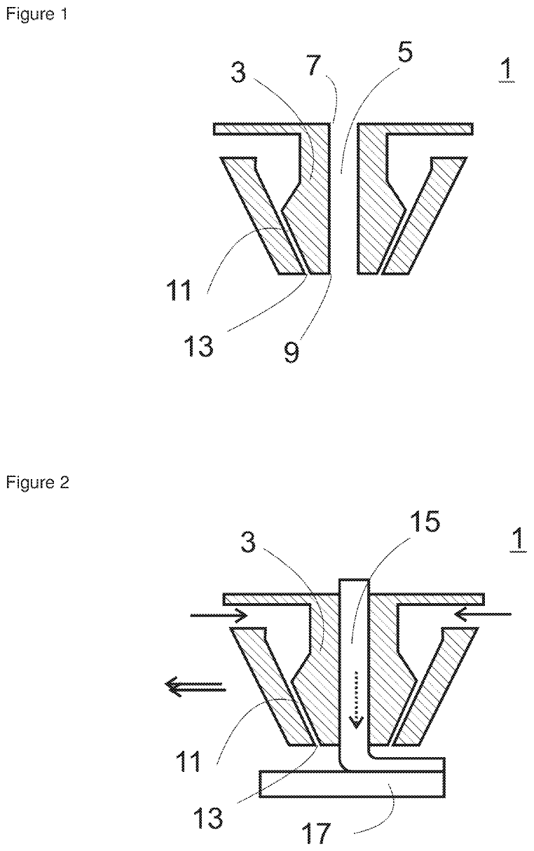

Some examples will be mentioned in the following part of the description of the present invention in order to facilitate the understanding of the invention. With this purpose, the FIG. 1 and FIG. 2 will be referred in the description.

FIG. 1 shows an extrusion head arrangement according to an embodiment of the present invention.

FIG. 2 shows the extrusion head arrangement according to FIG. 1 an in addition a filament and a substrate and part of the layer deposited.

An extrusion head arrangement 1 is disclosed comprising a body 3 with a filament channel 5 with material entrance opening 7 and material exit opening 9 forming a nozzle for the extrusion of flowable material through the exit opening 9 onto a substrate. The extrusion head in addition comprises a stream channel arrangement 11 with one or more stream channel openings 13 which allows to create a fluid stream close to the exit opening 9 and in direction to the substrate.

As can be seen in FIG. 2 a filament 15 is fed through the filament channel 5 onto a surface of a substrate 17 which might be the base substrate or the actually last layer deposited. The broken arrow shows the direction of the filament feed. The double arrow shows the X-Y movement of the nozzle. The single arrows show the flow direction of the fluid.

In the extrusion head arrangement 1 the stream channel arrangement 11 can comprise one or more stream channel openings 13 arranged coaxially to the nozzle.

In the extrusion head arrangement 1 the exit opening 9 and the one or more stream channel openings 13 can be arranged in a plane. The stream channel can be an annular stream channel.

The extrusion head arrangement 1 can comprise a gas feed system to feed at least one of the one or more stream channels with a gas stream.

The gas feed system can be designed to enable setting the temperature of the gas.

The gas feed system can be designed to enable heating the gas at least 20° C. above room temperature.

The gas feed system can be designed to enable mixing a powder to the gas.

The gas feed system can be designed to enable to at least partially ionizing the gas.

An apparatus for fused deposition modeling is disclosed comprising an extrusion head arrangement 1 with one or more of the features as described above.

A method to manufacture a three dimensional object is disclosed comprising the steps of

a) providing a filament 15 of thermoplastic material

b) extruding the filament 15 through the nozzle of an extrusion head arrangement 1 as described in any of the above mentioned embodiments and depositing a layer of the thermoplastic material on a surface below the nozzle by moving the nozzle in an X-Y plane.

c) repeating step b) multiple times in order to deposit multiple layers of thermoplastic material.

The method comprises as well a step (hereinafter referred to as step b1) where at least one time after the first layer deposited according to step b) and before the last layer to be deposited according to step c) a fluid to at least part of the last already deposited layer is applied wherein preferably the fluid is applied simultaneously with the deposit of a layer wherein preferably the fluid is applied simultaneously with the deposit of a layer.

In the method the extrusion head arrangement 1 is an extrusion head arrangement 1 can be the arrangement as described above.

The fluid can comprise a gas, preferably air and most preferred hot air.

The fluid can be a mixture of the gas and powder particles. Some of the powder particles, preferably all of the powder particles can be metallic particles.

Preferably step b1 is performed at least half as often as step c).

1. An extrusion head arrangement comprising a body with a filament channel with material entrance opening and material exit opening forming a nozzle for the extrusion of flowable material through the exit opening onto a substrate wherein the extrusion head arrangement in addition comprises a stream channel arrangement with one or more stream channel openings which allows to create a fluid stream close to the exit opening and in direction to the substrate.

2. The extrusion head arrangement according to claim 1 wherein the stream channel arrangement comprises one or more stream channels as well as one or more stream channel openings, wherein the stream channel openings are arranged coaxially to the nozzle or wherein the one or more stream channels are annular.

3. The extrusion head arrangement according to claim 1 wherein the exit opening and the one or more stream channel openings are arranged in a plane.

4. The extrusion head arrangement according to claim 1 wherein the extrusion head arrangement comprises a gas feed system to feed at least one of the one or more stream channels with a gas stream.

5. The extrusion head arrangement according to claim 4, wherein the gas feed system is designed to enable setting the temperature of the gas.

6. The extrusion head arrangement according to claim 4 wherein the gas feed system is designed to enable heating the gas at least 20° C. above room temperature.

7. The extrusion head arrangement according to claim 4 wherein the gas feed system is designed to enable mixing a powder to the gas.

8. The extrusion head arrangement according to claim 4 wherein the gas feed system is designed to enable to at least partially ionizing the gas.

9. An apparatus for fused deposition modeling comprising a body with a filament channel with material entrance opening and material exit opening forming a nozzle for the extrusion of flowable material through the exit opening onto a substrate wherein the extrusion head arrangement in addition comprises a stream channel arrangement with one or more stream channel openings which allows to create a fluid stream close to the exit opening and in direction to the substrate.

10. A method to manufacture a three dimensional object comprising the steps of
a) providing a filament of thermoplastic material
b) extruding the filament through the nozzle of an extrusion head arrangement according to claim 1 and depositing a layer of the thermoplastic material on a surface below the nozzle by moving the nozzle in an X-Y plane,
c) repeating step b) multiple times in order to deposit multiple layers of thermoplastic material wherein in a step b1) at least one time after the first layer deposited according to step b) and before the last layer to be deposited according to step c) applying a fluid to at least part of the last already deposited layer, wherein preferably the fluid is applied simultaneously with the deposit of a layer.

11. The method according to claim 10 wherein the fluid comprises a gas, preferably air and most preferred hot air.

12. The method according to claim 10 wherein the fluid is a mixture of a gas and powder particles.

13. The method according to claim 12, wherein some of the powder particles, preferably all of the powder particles are metallic particles.

14. The method according to claim 12, wherein some of the particles are colored particles.

15. The method according to claim 10 wherein step b1 is performed at least half as often as step c).
